(19) United States
(12) Patent Application Publication
(10) Pub. No.: US 2013/0063385 A1
(43) Pub. Date: Mar. 14, 2013

(54) PORTABLE INFORMATION TERMINAL AND METHOD FOR CONTROLLING SAME

(71) Applicant: Masaaki Nishio, Osaka (JP)

(72) Inventor: Masaaki Nishio, Osaka (JP)

(73) Assignee: SHARP KABUSHIKI KAISHA, Osaka (JP)

(21) Appl. No.: 13/697,725

(22) PCT Filed: Feb. 8, 2011
(86) PCT No.: PCT/JP2011/052575

§ 371 Date: Nov. 13, 2012

(30) Foreign Application Priority Data
May 14, 2010 (JP) 2010-111704

(51) Int. Cl. G06F 3/041

(52) U.S. Cl. 345/173

(57) ABSTRACT

The disclosed portable information terminal (10) is compact enough to be held in one hand, and when the device is being held in one hand by a user, the thumb of one hand placed on a display area (14) is detected by a transparent touch panel provided on the display area (14). At the time of detection, the terminal returns from standby mode, and therefore, a command will not be erroneously executed. Also, operation input is recognized resulting from a finger (aside from the thumb) approaching, touching, or pressing a touch panel (261) provided on the reverse side from the surface to which the display area (14) is provided, and a pre-associated process command is executed in response to the finger operation input that was recognized, and therefore, a suitable operation input interface for one hand is achieved.

### TECHNICAL FIELD

The present invention relates to a portable information terminal that has a display area, and more particularly, to a portable information terminal provided with a sensor for detecting a finger of a hand of a user approaching, touching, or pressing the back of the display area.

### BACKGROUND ART

In recent years, for a portable information terminal that requires operation such as menu selection, a portable information terminal equipped with a touch panel has been increasingly used. Such touch panel is capable of responding to operations, such as desired menu selection, resulting from a pen or a finger pressing the panel in accordance with the display on a screen. In order to detect a pressed position on the panel in such portable information terminal, various known touch panels, such as a resistive touch panel, a capacitive touch panel, a touch panel using an optical sensor, and a touch panel using infrared light, have been employed.

Japanese Patent Application Laid-Open Publication No. 2006-53678 discloses a structure of a notebook computer equipped with such touch panel and a configuration of a user interface displayed on a display screen of this device such as a virtual keyboard and a virtual mouse. This exemplary device is referred to as a first conventional example below.

U.S. Pat. No. 5,543,588 discloses a configuration of a portable computer terminal that is equipped with a touch pad provided on a back of a display area and that is to be held in one hand while fingers of the other hand are making an input on the touch pad. This exemplary device is referred to as a second conventional example below.

Japanese Patent Application Laid-Open Publication No. 2000-278391 discloses a configuration of a portable phone that is equipped with a touch panel provided on a back of a display area and that is capable of recognizing hand-written letters written on the touch panel, scroll control on a screen, and the like. This exemplary device is referred to as a third conventional example below.

### RELATED ART DOCUMENTS

### Patent Documents

Patent Document 1: Japanese Patent Application Laid-Open Publication No. 2006-53678
Patent Document 2: U.S. Pat. No. 5,543,588
Patent Document 3: Japanese Patent Application Laid-Open Publication No. 2000-278391

### SUMMARY OF THE INVENTION

### Problems to be Solved by the Invention

Of the conventional portable information terminals described above, for the device such as the first conventional example that is to be placed on a desk or the like upon using even if the device is portable, such as a notebook computer, a configuration in which input is received on a displayed interface screen such as a virtual keyboard and a virtual mouse is considered suitable.

However, for a portable information device that is to be operated while being held in one hand, such as a portable phone terminal and a PDA (Personal Digital Assistant) device, operations made by using the virtual keyboard, the virtual mouse, and the like as described in the first conventional example are not necessarily considered suitable.

Further, a device that is to be held in one hand while the other hand are making an input on the touch pad as described in the second conventional example requires both hands to operate the device. Therefore, such device cannot be considered suitable for operation to be made by one hand while holding the device in the same hand.

The device in the third conventional example is to be held and operated by one hand. However, it is very difficult to input letters on a touch pad disposed on the back using the fingers of the hand holding the device while looking at the display screen. The device may be suitable for single operation such as scrolling of the screen, but the device is not made for achieving a wide variety of operations. Therefore, operability is not substantially improved in the third conventional example as compared with a regular portable phone (which is usually operated by one hand), and therefore, the third conventional example cannot be considered to have an input interface suited for operation to be made by one hand.

The present invention aims at providing a compact portable information terminal that is to be held in one hand and that is provided with an input interface suited for operation to be made by one hand, and a method of controlling thereof.

### Means for Solving the Problems

A first aspect of the present invention is a portable information terminal equipped with a case that can be held in one hand of a user, including:

a display area disposed on a front surface that is a prescribed surface of the case, the display area being provided to display an image;

a rear input section disposed on a back surface that is a surface of the case on a reverse side from the front surface, the rear input section being provided to receive an operation input resulting from two or more fingers of the user approaching, touching, or pressing the rear input section;

a hold detection section that detects holding of the case by the user; and

a command recognition section that recognizes an operation input resulting from the fingers approaching, touching, or pressing the rear input section, the command recognition section executing a pre-associated process command in response to the recognized operation input made by the finger,

wherein, when the hold detection section does not detect holding of the case, the command recognition section switches to a command non-receiving state in which the process command is not executed, and when the hold detection section detects holding of the case, the command recognition section switches to a command receiving state in which the process command can be executed.

A second aspect of the present invention is the portable information terminal in the first aspect of the present invention, wherein the hold detection section is disposed on the front surface of the case, and detects holding of the case by detecting a thumb of the user approaching, touching, or pressing the hold detection section.

A third aspect of the present invention is the portable information terminal in the second aspect of the present invention, wherein the hold detection section has a front input section that can obtain two or more coordinates on the display area, including coordinates that the thumb of the user approached, touched, or pressed, and the hold detection section detects holding of the case when the front input section obtains fixed coordinates in the display area that are to be approached, touched, or pressed by the thumb of the user when the case is held.

A fourth aspect of the present invention is the portable information terminal in the third aspect of the present invention, wherein, during a period in which the command recognition section is in the command non-receiving state, the front input section obtains the coordinates by performing at least one of the following operations: limiting an area of the coordinates to be obtained on the display area to an area of the fixed coordinates or to an area near the fixed coordinates; and setting a time interval at which coordinates on the display area are to be obtained longer than the time interval during the command receiving state.

A fifth aspect of the present invention is the portable information terminal in the first aspect of the present invention, wherein the hold detection section is disposed on a side face that is a face of the case different from the back surface and the front surface, and the hold detection section detects holding of the case by detecting a hand of the user approaching, touching, or pressing the hold detection section.

A sixth aspect of the present invention is the portable information terminal in the first aspect of the present invention,

wherein the rear input section receives input made by four fingers other than the thumb of the user, and

wherein, when one of the fingers that at one time approached, touched, or pressed the rear input section was moved away or stopped touching or pressing the rear input section, and thereafter approached, touched, or pressed the rear input section again, the command recognition section executes a pre-associated process command in response to an operation input by the finger.

A seventh aspect of the present invention is the portable information terminal in the first aspect of the present invention,

wherein, when coordinates that the fingers approach, touch, or press are changed, the command recognition section executes a pre-associated process command in response to the change.

An eighth aspect of the present invention is a method of controlling a portable information terminal equipped with a case that can be held in one hand of a user, the method including:

a display step of displaying an image on a display area disposed on a front surface that is a prescribed surface of the case;

a rear input step of receiving an operation input resulting from two or more fingers of the user approaching, touching, or pressing a rear input section disposed on a back surface that is a surface of the case on a reverse side from the front surface;

a hold detection step of detecting holding of the case by the user; and

a command recognition step of recognizing an operation input made in the rear input step by the fingers approaching, touching, or pressing the rear input section, and executing a pre-associated process command in response to a recognized operation input made by the finger,

wherein, in the command recognition step, when holding of the case is not detected in the hold detection step, the process command is not executed, establishing a command non-receiving state, and when holding of the case is detected in the hold detection step, the process command can be executed, establishing a command receiving state.

### Effects of the Invention

According to the first aspect of the present invention, the rear input section receives the operation input resulting from two or more fingers of the user approaching, touching, or pressing the rear input section, and the hold detection section detects holding of the case by the user. Further, the command recognition section executes pre-associated process commands in response to the recognized finger operation input. When holding of the case is not detected, the command recognition section switches to the command non-receiving state in which the command recognition section does not execute the process commands, and when holding of the case is detected, the command recognition section switches to the command receiving state in which the command recognition section can execute the process commands. Therefore, an input interface suited for an operation to be made by one hand is achieved. Further, when the device is not held, the device switches to the command non-receiving state, thereby preventing the commands from being accidentally executed due to an unintentional touch on the display screen, and the like. Therefore, an input interface further suited for an operation to be made by one hand is achieved.

According to the second aspect of the present invention, the hold detection section is disposed on the front surface of the case. A holding of the case is detected by detecting the thumb of the user approaching, touching, or pressing the hold detection section. Therefore, the holding of the device can be easily and reliably detected in a natural manner.

According to the third aspect of the present invention, the input section on the front surface, which can obtain two or more coordinates, detects holding of the case when the fixed coordinates defined on the display area are obtained. Therefore, the display area can be made large on the front surface of the case, and a need for providing additional sensors for detecting a thumb can be eliminated.

According to the fourth aspect of the present invention, an area of the coordinates to be obtained is limited, or a time interval at which coordinates to be obtained is set longer, during the command non-receiving state. Therefore, it becomes possible to reduce power consumption of the device.

According to the fifth aspect of the present invention, the hold detection section is provided on a side face of the case, and detects a hand approaching, touching, or pressing the hold detection section. This way, the detection of holding of the case can be achieved with a simple configuration.

According to the sixth aspect of the present invention, the input section on the back surface receives input from four fingers other than the thumb of the user, and the command recognition section executes the pre-associated process commands when one of the fingers that had approached, touched, or pressed the input section on the back surface was moved away or stopped touching or pressing the input section on the back surface, and thereafter approached, touched, or pressed the input section on the back surface again. Therefore, it becomes possible to execute various commands by making a finger gesture suitable for an operation to specify the commands, which is the finger gesture described above (also referred to as a click gesture) that can be performed particularly intuitively.

According to the seventh aspect of the present invention, when the coordinates that the fingers approached, touched, or pressed are changed, the command recognition section executes the pre-associated process commands in response to the change. Therefore, it becomes possible to execute various commands by making a finger gesture suitable for an operation to specify the commands, which is the finger gesture described above (also referred to as a slide gesture) that can be performed particularly intuitively.

According to the eighth aspect of the present invention, the same effect as that of the first aspect of the present invention can be achieved in a method of controlling a portable information terminal.

### BRIEF DESCRIPTION OF THE DRAWINGS

FIG. 1 is an exterior perspective view of a portable information terminal on a side of a display surface according to one embodiment of the present invention.

FIG. 2 is a block diagram showing a main configuration of a display area and an input section of the portable information terminal shown in FIG. 1 according to the above-mentioned embodiment.

FIG. 3 is an exterior perspective view of the portable information terminal showing a reverse side from the display surface according to the above-mentioned embodiment.

FIG. 4 is a block diagram showing a main configuration that corresponds to the input section of the portable information terminal shown in FIG. 3 according to the above-mentioned embodiment.

FIG. 5 is a block diagram showing a configuration of the portable information terminal according to the above-mentioned embodiment.

FIG. 6 is a flowchart showing an entire process flow of the portable information terminal according to the above-mentioned embodiment.

FIG. 7 is a flowchart showing a flow of a command input process (Step S2) in detail according to the above-mentioned embodiment.

FIG. 8 is a diagram showing a positional relationship between a display screen of the portable information terminal and a left thumb of a user, and an area of fixed coordinates provided near the left thumb according to the above-mentioned embodiment.

FIG. 9 is a diagram showing a positional relationship among the fingers of the user that are placed on a back of the display screen of the portable information terminal, and a group of the input coordinates according to the above-mentioned embodiment.

FIG. 10 is a flowchart showing a flow of a recognition process (Step S3) in detail according to the above-mentioned embodiment.

FIG. 11 is a diagram showing four mode names of the portable information terminal and names of commands that are available in the respective modes and that are assigned to corresponding fingers according to the above-mentioned embodiment.

FIG. 12 is a diagram showing one example of a hold detection sensor in a modification example of the above-mentioned embodiment.

FIG. 13 is a diagram showing another example of the hold detection sensor in the modification example of the above-mentioned embodiment.

FIG. 14 is a diagram showing yet another example of the hold detection sensor in the modification example of the above-mentioned embodiment.

### DETAILED DESCRIPTION OF EMBODIMENTS

### 1. Overall Configuration and Operation of Device

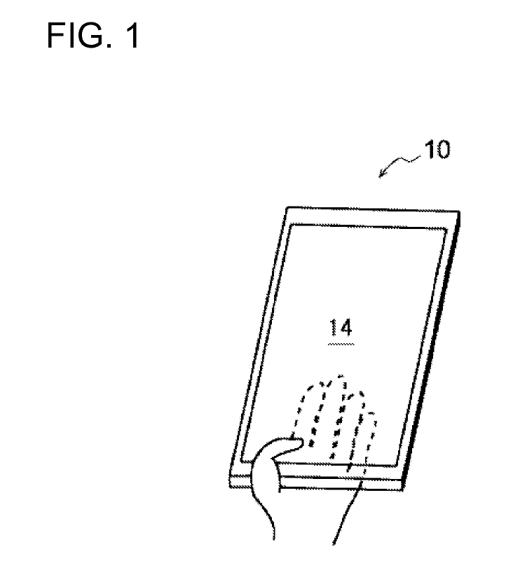

FIG. 1 is an exterior perspective view of a portable information terminal on a side of a display surface according to one embodiment of the present invention. As shown in FIG. 1, a portable information terminal 10 has a display area 14. The portable information terminal 10 is held in one hand of a user when the user holds the device with a thumb and other fingers (typically, of a non-dominant hand of the user) respectively supporting an area near a lower center of the device and a back surface thereof. The portable information terminal 10 is made to have a suitable shape and weight balance for being held in one hand in a manner as described, and is typically used for browsing documents such as electronic books.

On a top surface (front surface) of the display area 14, a transparent touch panel that functions as an input section is provided. When a finger (typically, of a dominant hand of the user), a pen, or the like presses (or touches) a screen, a pressed position (or a touched position) on the screen is detected. A configuration and the like of the display area and the touch panel will be described later.

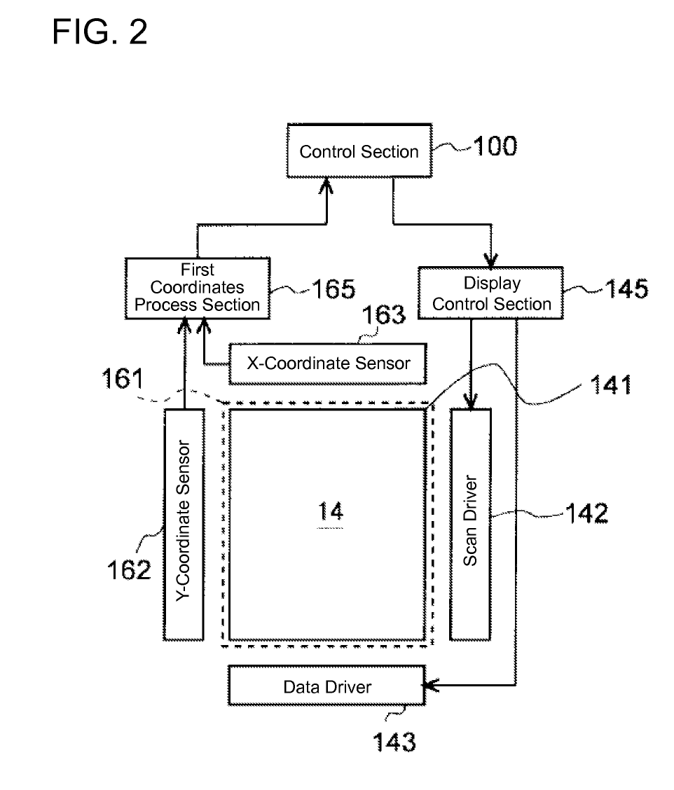

FIG. 2 is a block diagram showing a main configuration that corresponds to the display area and the input section of the portable information terminal shown in FIG. 1 according to one embodiment of the present invention. The portable information terminal 10 is provided with a control section 100, a liquid crystal panel 141 that has the display area 14, a scan driver 142 and a data driver 143 that drive the liquid crystal panel 141, a display control circuit 145, a matrix type resistive touch panel 161 disposed on the liquid crystal panel 141, an X-coordinate sensor 163 and a Y-coordinate sensor 162 that detect a position pressed by a finger of the user, a pen, or the like on the touch panel 161, and a first coordinates process section 165.

The touch panel 161 is not a typical resistive touch panel that detects contact points on two resistance films disposed to face each other in analog form. The touch panel 161 is provided with a large number of transparent electrodes arranged in parallel along a row direction, and a large number of transparent electrodes arranged in parallel along a column direction and in a direction perpendicular to the above-mentioned transparent electrodes so as to face the above-mentioned transparent electrodes, having a prescribed short distance therebetween. The X-coordinate sensor 163 is connected to each of the electrodes arranged along the column direction. The Y-coordinate sensor 162 is connected to each of the electrodes arranged along the row direction. This way, when the electrodes respectively arranged in the row direction and in the column direction intersecting with each other make contact with each other at positions where a finger of the user, a pen, or the like presses, the pressed positions can be detected by the X-coordinate sensor 163 and the Y-coordinate sensor 162. Consequently, a large number of coordinates on the touch panel 161 can be recognized individually in accordance with a resolution suited for an array pitch of the electrodes.

For a so-called multi-touch panel that can recognize a large number of coordinates individually, various known touch panels, such as a matrix type capacitive touch panel, a touch panel using optical sensors, and a touch panel using mechanical sensors, can be employed. Alternatively, a plurality of so-called single touch panels that can recognize only one set of coordinates may be combined. Generally, it is more preferable to use the capacitive touch panel and the touch panel using the optical sensors in most cases, because, unlike the resistive touch panel, the user does not have to press a finger against the capacitive touch panel or the touch panel using the optical sensors, but is only required to lightly touch or place a finger near the touch panel.

The liquid crystal panel 141 is an active matrix liquid crystal panel. The scan driver 142 and the data driver 143 select respective pixels in the liquid crystal panel and provide data, and an image representing an electronic document and the like, for example, is formed.

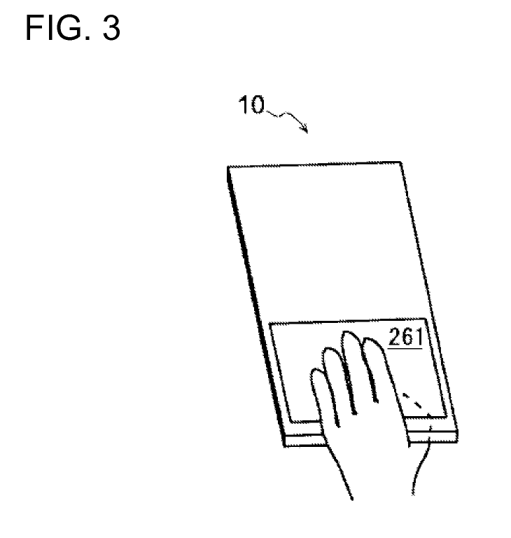

FIG. 3 is an exterior perspective view of the portable information terminal showing a reverse side from the display surface. As shown in FIG. 3, the portable information terminal 10 is provided with a touch panel 261 that functions as an input section on a back surface disposed on a surface on the back of the display area 14 shown in FIG. 1. The portable information terminal 10 is held in one hand of the user when the user holds the device with a thumb and other fingers (typically, of a non-dominant hand of the user) respectively supporting an area around the lower part of the display area 14 and a part of the touch panel 261 as described above.

The touch panel 261 has the same configuration as that of the matrix type resistive touch panel 161 described above. For the touch panel 261, various known touch panels can be employed as long as the touch panels can recognize a large number of coordinates individually. Further, because the touch panel 261 is not disposed on the display surface, unlike the touch panel 161, the touch panel 261 does not need to be transparent, and needs to have an area for the fingers (excluding the thumb) of the hand holding the device to touch. The touch panel 261 may detect approach of the fingers of the hand holding the case. That is, the touch panel 261 may be provided in an inside of the case and near a back panel (or an inner side of the back panel), which forms the back of the case, and may detect the approach of the fingers of the hand that supports an outer side of the back panel.

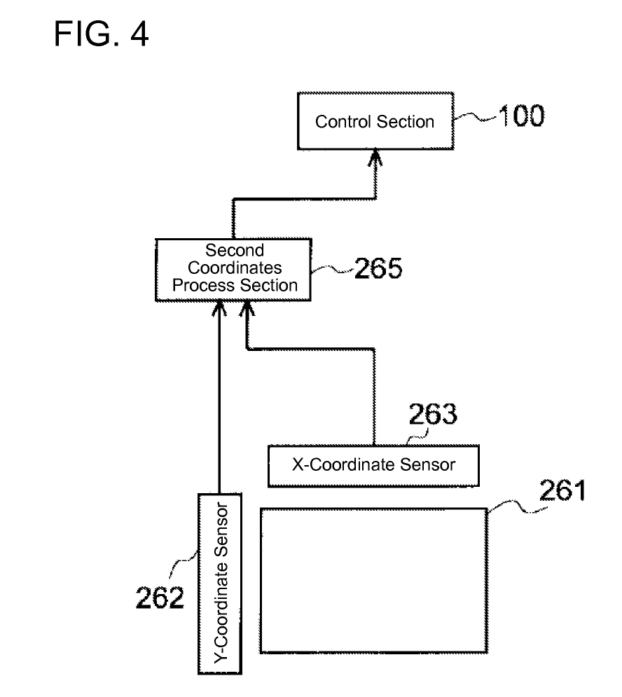

FIG. 4 is a block diagram showing a main configuration that corresponds to the input section of the portable information terminal shown in FIG. 3. The portable information terminal 10 is provided with the control section 100 and the touch panel 261, which were described above, an X-coordinate sensor 263 and a Y-coordinate sensor 262 that detect a pressed position on the touch panel 161, and a second coordinates process section 265. These components have the same functions as those of the components described above with reference to FIG. 2, and therefore, the description thereof will not be repeated.

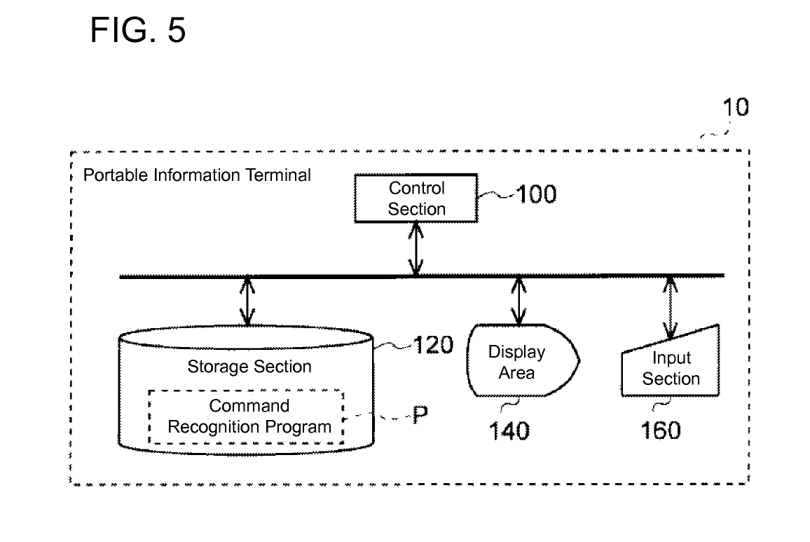

FIG. 5 is a block diagram showing a configuration of the portable information terminal according to one embodiment of the present invention. This portable information terminal 10 is a device that performs prescribed processes by a typical (dedicated) operating system and prescribed application software. This portable information terminal 10 is provided with the control section 100 constituted of a CPU (Central Processing Unit), a semiconductor memory such as a RAM, and the like, a memory section 120 that has a non-volatile semiconductor memory such as an EPROM, the display area 140 constituted of a liquid crystal panel and the like, and an input section 160 that has an operation input unit such as the touch panels 161 and 261.

The control section 100 in the portable information terminal 10 has a function of recognizing a press gesture made by the fingers of the user, gestures that will be described later, and the like, which were received through the input section 160, and performing prescribed command processes. The operation of the control section 100 will be described later in detail.

The above-mentioned functions of the control section 100 are achieved by the CPU executing a prescribed command recognition program P (application software for recognizing a press gesture made by the fingers, gestures that will be described later, and the like, for example) that is stored in the semiconductor memory. The command recognition program P is written on the EPROM at the time of manufacturing. Alternatively, the command recognition program P may be written after manufacturing by a CD-ROM that is a recording medium storing the program P, other recording media, or communication lines, for example. When a prescribed operation is performed to start up the portable information terminal 10, part or all of the command recognition program P written on the memory section 120 is transferred to the semiconductor memory such as the RAM and is temporarily stored therein. Thereafter, the command recognition program P is executed by the CPU in the control section 100. This way, control processes of the respective sections in the control section 100 is achieved.

### 2. Overall Operation of the Portable Information Terminal

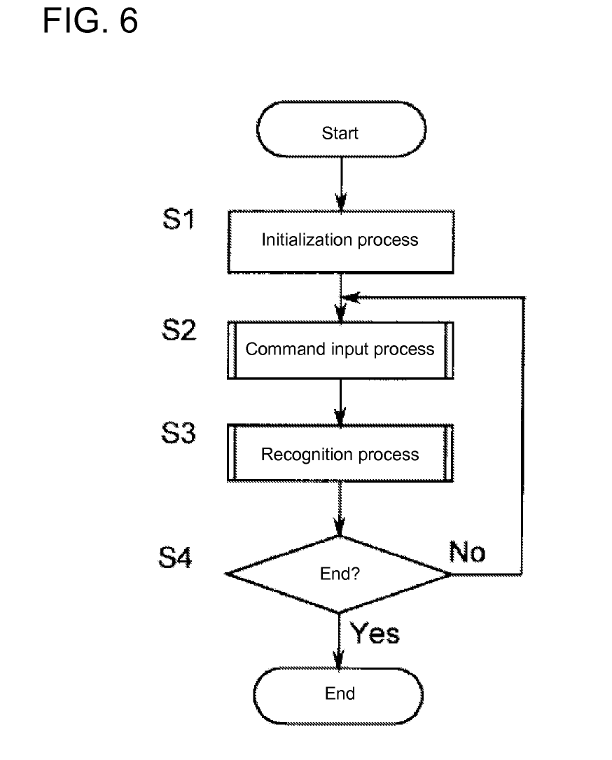

Next, overall operation of the portable information terminal 10 will be explained. FIG. 6 is a flowchart showing an entire process flow of the portable information terminal 10. In Step S1 (initialization process) shown in FIG. 6, the control section 100 in the portable information terminal 10 receives a start command that is typically given by the user, and image data corresponding to an electronic document to be presented to the user, for example, is selected. Further, respective values required for processes, which will be described later, are initialized.

This portable information terminal 10 can have various known built-in application software. Here, the portable information terminal 10 has built-in application software for reading electronic books, which is for browsing electronic book data stored in the memory section 120, and built-in application software for editing documents, which is for creating and editing various types of documents.

Next, in Step S2 (command input process), the control section 100 displays the image that has been selected in Step S1 on the display area 140, and receives an operation input made by the user through the input section 160, which is an operation input resulting from the fingers touching the touch panel 261 for specifying a command. Here, the control section 100 may receive an operation input resulting from the fingers touching the touch panel 161 or making prescribed gestures for specifying a corresponding command.

In Step S3 (recognition process), the control section 100 recognizes a corresponding process command in response to the operation input received in Step S2, and displays an image that corresponds to the recognized process command on the display area 140.

In Step S4, the control section 100 determines whether or not the respective processes should be terminated due to the user's instruction to stop, passage of prescribed time that starts a sleep process, or the like. If the process is not terminated, the flow returns to Step S2 and the above-mentioned processes are repeated (S4→S2→S3→S4). If the process is terminated, the portable information terminal 10 temporarily terminates the process. The portable information terminal 10 starts the above-mentioned processes again when, typically, the user instructs the device to start up.

### 3. Command Input Process Operation of the Portable Information Terminal

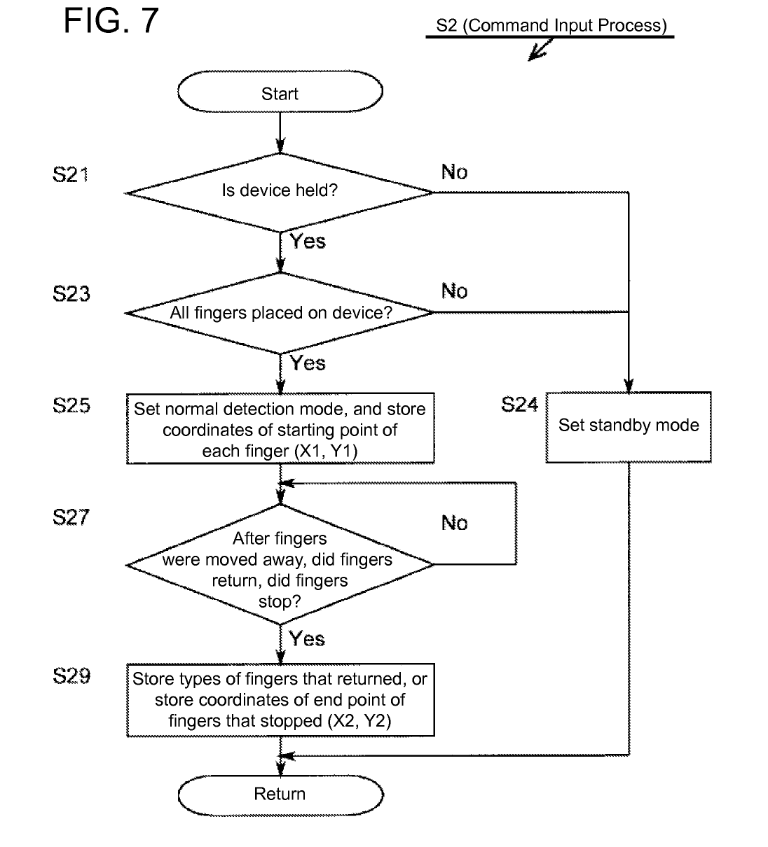

Next, the command input process (Step S2) operation of the portable information terminal 10 will be described in detail. FIG. 7 is a flowchart showing a flow of the command input process (Step S2) in detail.

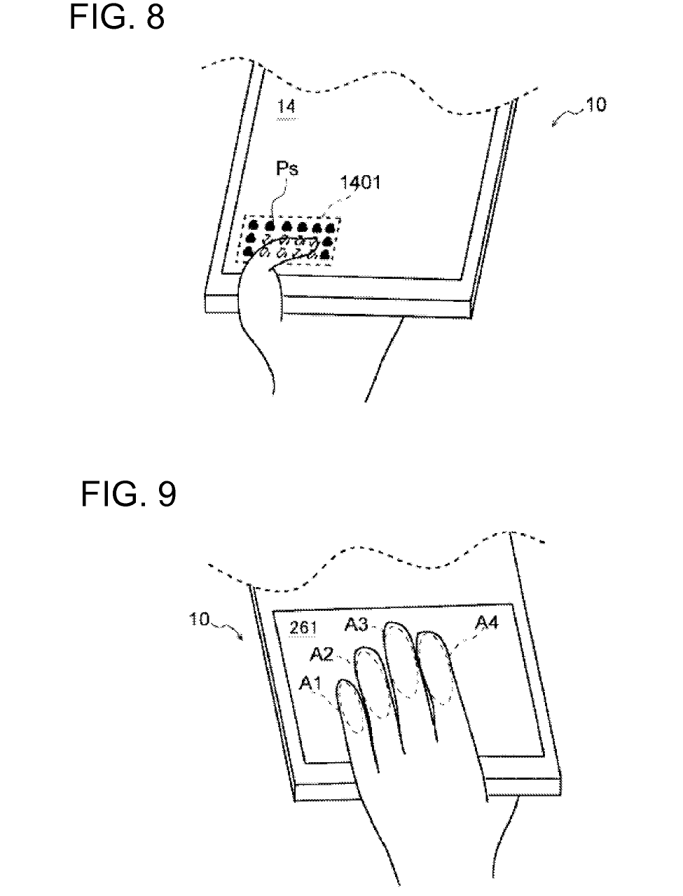

In Step S21 shown in FIG. 7, the control section 100 determines whether or not (typically) the thumb of the user is placed on fixed coordinates that are placed in a predefined position on the touch panel 161, in order to detect holding of the device. Specifically, the control section 100 determines by comparison whether or not coordinates in an area of the fixed coordinates are included in a group of input coordinates input to the touch panel 161 and received by the input section 160. This area of the fixed coordinates will be described below with reference to FIG. 8.

FIG. 8 is a diagram showing a positional relationship between a display screen of the portable information terminal and a left thumb of the user, and the area of the fixed coordinates provided near the left thumb. As described above, the portable information terminal 10 is held in one hand of the user in a natural manner with the thumb and the other fingers of a non-dominant hand of the user (here, a left hand is given as an example for a purpose of illustration) respectively supporting a part around the lower center of the device and the back of the device. FIG. 8 shows the left thumb. It is apparent that the device may be held in a dominant hand, an artificial hand, or the like.

As shown in FIG. 8, the display area 14 (and the transparent touch panel 161 disposed on the display area 14) is provided with an area of fixed coordinates 1401 on a lower part. The area of the fixed coordinates 1401 has a plurality of detection points Ps inside the area. The detection points Ps make it possible to detect coordinates of a pressed position through the input section 160. Of the detection points Ps, the detection points Ps that correspond to coordinates located in a position being actually pressed are shown with shaded circles, and the detection points Ps that correspond to coordinates located in a position not being pressed are shown with black circles. The coordinates represented by the shaded circles are a part or all of the group of the coordinates received by the input section 160. The control section 100 determines whether or not this group of the coordinates matches one or more coordinates (two or more coordinates in order to prevent erroneous detection) located in the area of the fixed coordinates. The above-mentioned method of determining whether or not the coordinates corresponding to the position of the left thumb are found in the area of the fixed coordinates is one example. The determination can be made by any other known methods. Alternatively, the area of the fixed coordinates may not be provided. The determination may be made by recognizing a press of the thumb, which is detected by a pattern of the coordinates pressed by the thumb. As described above, if the thumb of the hand holding the device is to be detected by the touch panel 161 disposed on the display area 14, the display area 14 can be made large on the front surface of the case.

In Step S21, the control section 100 determines whether or not the finger is placed on the fixed coordinates as described above. If the control section 100 determines that the finger is placed on the fixed coordinates and the device is held (Yes in Step S21), and if the control section 100 further determines that all of the remaining four fingers (i.e., the fingers excluding the thumb) are placed on the touch panel 261 disposed on the back of the display area 14 in Step S23 (Yes in Step S23), the flow proceeds to Step S23. Consequently, the control section 100 becomes capable of receiving commands that will be described later (also referred to as “command receiving state” below).

In order to determine whether or not all of the four fingers are placed on the touch panel 261 in Step S23, the control section 100 may determine whether or not the coordinates that are detected when the corresponding fingers press the touch panel are included in the fixed coordinates, which are predefined for the respective fingers, in the same manner as the process in Step S21. Here, in order to accurately determine whether or not the plurality of fingers are placed on the touch panel 261, it is preferable to employ a known determination method in which a known pattern recognition or the like is employed, a method in which the pressing of the respective fingers is determined by separating the groups of the input coordinates into four patterns, or the like, rather than employing the above-mentioned determination method in which the fixed coordinates are used.

FIG. 9 is a diagram showing a positional relationship among the fingers of the user that are placed on the back of the display screen of the portable information terminal, and the groups of the input coordinates. As shown in FIG. 9, the touch panel 261 is pressed by a left little finger, a left ring finger, a left middle finger, and a left index finger of the user. Specifically, by pressing the touch panel 261 using the respective fingers, the corresponding groups of the input coordinates can be obtained in regions A1 to A4, respectively. The control section 100 determines whether or not these groups of the input coordinates can be separated into four (and whether or not characteristics of the respective patterns indicate a pressing of the respective fingers, and the like). This way, the control section 100 determines whether or not all of the four fingers are placed on the touch panel 261.

If the control section 100 determines that the device is not held (No in Step S21), or if the control section 100 determines that not all four fingers are placed on the touch panel (No in Step S23), the flow proceeds to Step S24. Consequently, the control section 100 becomes incapable of receiving the commands that will be described later (also referred to as “command non-receiving state” below). This command input process is thereby terminated, and the flow returns to the process shown in FIG. 6.

In Step S24, the control section 100 makes the device incapable of receiving the commands by setting an operation mode of the device to a standby mode. In this command non-receiving state, the processes to be performed in association with the command receiving state do not need to be performed. Therefore, it is preferable that the sensors be driven and the data be processed in a manner such that power consumed for driving the sensors and for data processing is reduced as follows, for example: lowering respective drive frequencies (sensor data read-out frequency) of the X-coordinate sensors 163 and 263 and the Y-coordinate sensors 162 and 262 that detect the coordinates on the touch panels 161 and 261 (detecting the coordinates every 60 frames, and the like, for example); lowering a drive frequency of a light source in case of using optical sensors; and not reading out sensor data of an area outside of the area of the fixed coordinates 1401 (and the adjacent area thereof) on the touch panel 161, not allowing for data processing and the like by the first and second coordinates process sections 165 and 265, and the like. When switching to the command receiving state, these sensor driving state and processing state return to the normal mode.

Further, the coordinates located outside the area of the fixed coordinates may be detected by the touch panel 161, and the coordinates located inside the area of the fixed coordinates may be detected by a resistive (single) touch sensor having a single electrode, by a mechanical sensor, or the like, which differs from the touch panel 161, so that the operation of the touch panel 161 can be completely stopped when the device becomes incapable of receiving the commands. This makes it possible to reduce power consumption in the command non-receiving state.

Next, in Step S25, the control section 100 makes the device capable of receiving the commands by setting the operation mode of the device to the normal mode. In this command receiving state, each of the operations or processes is performed in the normal mode as described above. Further, the control section 100 calculates respective reference coordinates of four groups of the input coordinates such as average coordinates and center coordinates, or coordinates located on the left upper corner, which were obtained on the touch panel 261. The control section 100 stores the reference coordinates as coordinates of a starting point (X1, Y1).

Next, in Step S27, the control section 100 determines whether or not any one of the remaining four fingers was temporarily moved away from and thereafter was placed back on the touch panel 261, or whether or not any one of the remaining four fingers was moved and thereafter was stopped on the touch panel 261. Specifically, if the reference coordinates that represent each of the four groups of the input coordinates described above or all or a large portion of the group of the input coordinates, which were received by the input section 160, disappeared (i.e., the corresponding coordinates are not input) and thereafter appeared again, the control section 100 determines that a click gesture (a tapping gesture) made by the fingers on the touch panel 261 has been completed. Alternatively, if the reference coordinates that represent each of the four groups of the input coordinates described above or all or a large portion of the group of the input coordinates were moved and thereafter stopped (or alternatively, or in addition to this operation, if the reference coordinates or all or a large portion of the group of the input coordinates were moved and thereafter disappeared), the control section 100 determines that a slide gesture (a gesture of sliding the fingers) performed by the fingers on the touch panel 261 has been completed. As described above, if the control section 100 determines that any one of the four fingers was temporarily moved away from and thereafter was placed back on the touch panel 261 (a click gesture) or that any one of the four fingers was moved and thereafter stopped (a slide gesture), which is Yes in Step S27, the flow proceeds to Step S29.

Here, for the slide gesture, a gesture of the fingers sliding up to down or down to up is only specified for a purpose of illustration. Specifically, in Step S27, when coordinates on the upper left corner are set to (0, 0) and a position where the reference coordinates or the group of the input coordinate were stopped after being moved is set to coordinates of an end point (X2, Y2), if the coordinates move to an upper direction in relation to the coordinates of a starting point (X1, Y1), which results in Y1>Y2, the control section 100 determines that the gesture of the finger sliding down to up was input. If the coordinates move to a lower direction in relation to the coordinates of the starting point, which results in Y1<Y2, the control section 100 determines that the gesture of the finger sliding up to down is input. For gestures of moving fingers including this slide gesture, various types of gestures are naturally possible. Any gestures can be employed as long as the gestures are detectable. Of the various gestures, the click gesture and the slide gesture described above are the gestures particularly easy to perform intuitively and are suited for the operation of selecting the commands.

If the control section 100 determines that the fingers are not performing the click gesture or the slide gesture described above (No in Step S27), this process (S27) is repeated until when the control section 100 determines that the above gestures were performed or when the control section 100 determines that a prescribed timeout period has passed. This timeout period is a period of time that is too long to be recognized as the time taken to perform the click gesture or the slide gesture, for example (about a second, for example).

This repetitive process is canceled also by a prescribed interrupt process or the like, and the flow proceeds to Step S29. In the above determination process, when the groups of the input coordinates or the reference coordinates move a prescribed distance or less, it is preferable that the control section 100 determine that this is not the slide gesture, in order to prevent erroneous determination.

Next, in Step S29, the control section 100 stores the position where the reference coordinates or the input coordinates reappeared or stopped (or the position where the coordinates disappeared) as coordinates of an end point (X2, Y2) to the memory section 120. Thereafter, this command input process is completed and the flow returns to the process shown in FIG. 6.

### 4. Recognition Process Operation of Portable Information Terminal

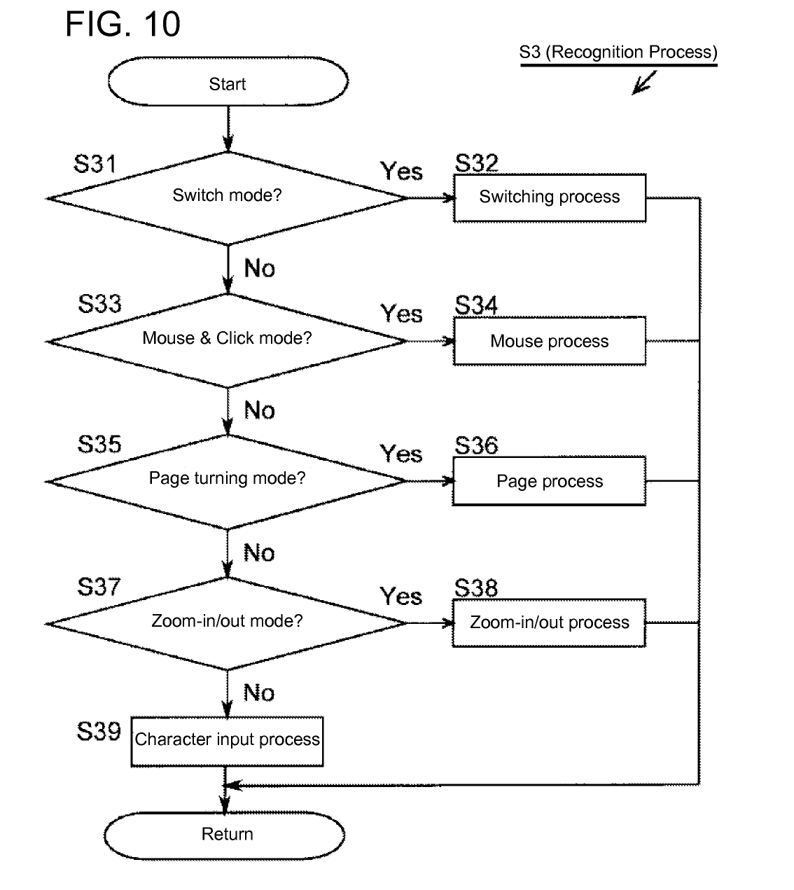

Next, operation of a recognition process (Step S3) by the portable information terminal 10 will be described in detail. FIG. 10 is a flowchart showing a flow of the recognition process (Step S3) in detail.

In Step S31 shown in FIG. 10, the control section 100 determines whether or not the user input a mode switching command. If the control section 100 determines that the mode switching command was input (Yes in Step S31), a switching process in Step S32 is performed. In this switching process, a process of sequentially switching respective modes, which will be described later, is performed. After the switching process (S32) is completed, this recognition process is completed and the flow returns to the process shown in FIG. 6. If the control section 100 determines that the mode switching command was not input (No in Step S31), the flow proceeds to Step S33.

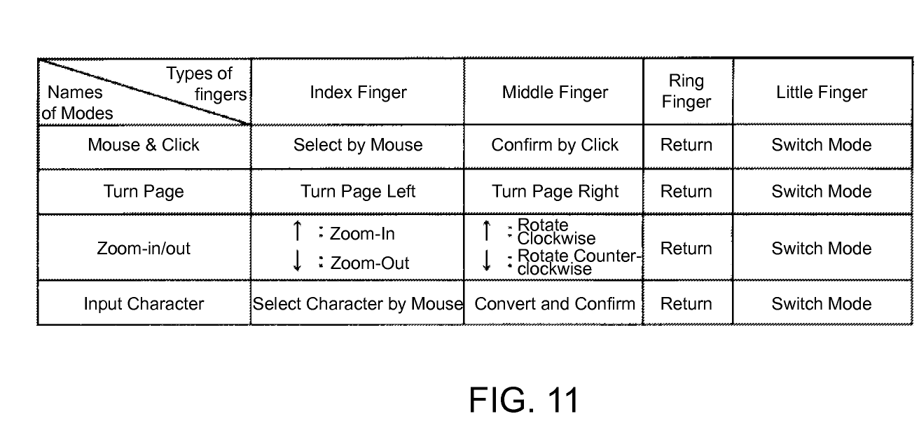

As described above, the portable information terminal 10 has built-in application software for reading electronic books and for editing documents. Such software receives commands that correspond to various processes when the fingers of the hand that is not the hand holding the device (here, a dominant hand) performs select operation by making a click gesture or the like, operation of moving a mouse, or the like, following a menu displayed on the display area 14. The portable information terminal 10 is configured such that respective commands in the four modes shown in FIG. 11 are executed by an operation input made to the touch panel 261 by the four fingers aside from the thumb holding the device.

FIG. 11 is a diagram showing four mode names of the portable information terminal in the present embodiment and command names in the respective modes that are assigned to the corresponding available fingers. As shown in FIG. 11, when a little finger makes an operation input in all of the modes (here, the click gesture in which the little finger is temporarily moved away from and is placed again on the touch panel 261), the control section 100 determines that the mode switching command was input. When a ring finger makes an operation input in all of the modes (the click gesture), the control section 100 determines that a return command was input, and thus, during the switching process described above or during respective processes that will be described later, operation of returning to the previous state (operation of returning to the mode before the mode was switched, for example) is performed.

Next, in Step S33, the control section 100 determines whether or not the current mode (the mode after the above-mentioned switching process was completed) is a mouse and click mode. If the control section 100 determines that the current mode is the mouse and click mode (Yes in Step S33), the control section 100 performs a mouse process in Step S34. As shown in FIG. 11, in this mouse process, when the index finger makes an operation input (a click gesture), a command of selecting operation by using the mouse is performed. When the middle finger makes an operation input (a click gesture), a command of confirming operation by clicking is executed. This way, the respective processes are performed in response to the respective commands. After this mouse process (S34) is completed, this recognition process is completed, and the flow returns to the process shown in FIG. 6. If the control section 100 determines that the current mode is not the mouse and click mode (No in Step S33), the flow proceeds to Step S35.

Next, in Step S35, the control section 100 determines whether or not the current mode (the mode after the above-mentioned switching process was completed) is a page turning mode. If the control section 100 determines that the current mode is the page turning mode (Yes in Step S35), the control section 100 performs the page turning process in Step S36. As shown in FIG. 11, in this page turning process, when the index finger makes an operation input (a click gesture), a page of a displayed document is turned left, i.e., a command of turning back one page (or two pages in a double spread) of the displayed document, is executed. When the middle finger makes an operation input (a click gesture), a page of the displayed document is turned right, i.e., a command of turning one page forward (or two pages in a double spread) of the displayed document, is executed. This way, the commands of selecting the operation by clicking are executed, and the respective processes are performed in response to the corresponding commands. After this page process (S36) is completed, this recognition process is completed, and the flow returns to the process shown in FIG. 6. If the control section 100 determines that the current mode is not the page turning mode (No in Step S35), the flow proceeds to Step S37.

Next, in Step S37, the control section 100 determines whether or not the current mode (the mode after the above-mentioned switching process was completed) is a zoom-in/out mode. If the control section 100 determines that the current mode is the zoom-in/out mode (Yes in Step S37), the control section 100 performs a zoom-in/out process in Step S38. In this zoom-in/out process, an operation input not by the click gesture but by the slide gesture, which is the gesture described above of the finger sliding up to down or down to up, is performed.

This slide gesture is shown by an up arrow or a down arrow in FIG. 11. To a gesture of the index finger sliding down to up, a command of zooming in a displayed image is assigned. To a gesture of the index finger sliding up to down, a command of zooming out the displayed image is assigned. This way, the commands corresponding to the respective slide gestures are executed, and the corresponding processes are performed. Further, to a gesture of the middle finger sliding down to up, a command of rotating the displayed image clockwise is assigned. To a gesture of the middle finger sliding up to down, a command of rotating the displayed image counterclockwise is assigned. This way, the commands corresponding to the respective slide gestures are executed, and the corresponding processes are performed. The specific method of determining the slide gestures is the same as described above in Step S27.

After this zoon-in/out process (S38) is completed, this recognition process is completed and the flow returns to the process shown in FIG. 6. If the control section 100 determines that the current mode is not the zoon-in/out mode (No in Step S37), the flow proceeds to a character input process in Step S39.

In the character input process, as shown in FIG. 11, when the index finger makes an operation input (a click gesture), a command of selecting a character by the mouse is executed. When the middle finger makes an operation input (a click gesture), a command of converting and confirming the character is executed. This way, the respective processes are performed in response to the corresponding commands. After this character input process (S39) is completed, this recognition process is completed and the flow returns to the process shown in FIG. 6.

### 5. Effects

As described above, the portable information terminal in the present embodiment, which is compact enough to be held in one hand, recognizes the operation resulting from the fingers (of the hand holding the device) approaching, touching, or pressing the touch panel 261 that is the input section on the back surface, and executes the pre-associated process commands in response to the recognized finger operation. Therefore, the present embodiment can provide an input interface suited for operation to be made by one hand.

When the thumb of the hand holding the device presses the position where the fixed coordinates near the center of the screen are located, the device becomes capable of receiving the commands. When the portable information terminal is not held, the device becomes incapable of receiving the commands, thereby preventing the commands from being accidentally executed due to an unintentional touch on the display screen, and the like. Therefore, the present embodiment can provide an input interface suited for the operation to be made by one hand.

Further, when the device is incapable of receiving the commands, the device switches to the standby mode and stops or suppresses the processes associated with receiving the commands (reading out the sensor data, processing data, and the like, for example), thereby reducing the power consumption.

### 6. Modification Examples

### 6.1 Main Modification Example

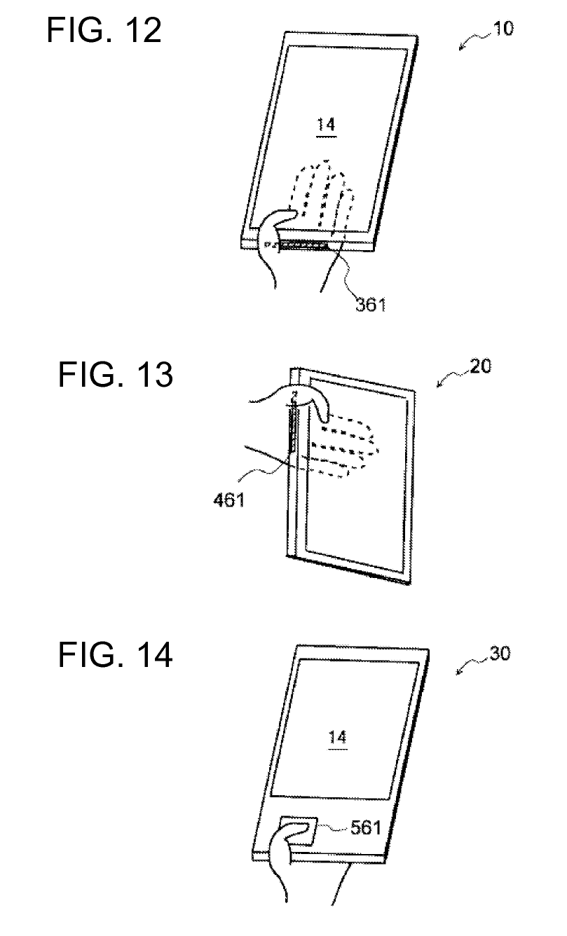

In the above-mentioned embodiment, the device is configured such that the control section 100 determines whether or not (typically) the thumb of the user is placed on the fixed coordinates that are placed on the predefined position on the touch panel 161, in order to detect holding of the device (Step S21). Alternatively, the device may be provided with additional sensors for detecting the holding of the device as shown in FIGS. 12 to 14.

FIG. 12 is a diagram showing one example of a hold detection sensor in a modification example of the above-mentioned embodiment. FIG. 13 is a diagram showing another example of the hold detection sensor in the modification example of the above-mentioned embodiment. FIG. 14 is a diagram showing yet another example of the hold detection sensor in the modification example of the above-mentioned embodiment.

A hold detection sensor 361 shown in FIG. 12 is a sensor having a known structure such as an optical sensor and a mechanical sensor that can detect a hand approaching, touching, or pressing the sensor. The hold detection sensor 361 is provided on a side face (a lower side face), which is different from the surfaces where the touch panels 161 and 261 are disposed. The hold detection sensor 361 is placed on a location where the sensor makes contact with the palm or the base of the thumb of the user when the device is held. Detecting the holding by this sensor eliminates a need of detecting the fixed coordinates, which allows a simple structure to detect the hold.

A hold detection sensor 461 shown in FIG. 13 is also a sensor for detecting a hand approaching, touching, or pressing the sensor in a similar manner. This hold detection sensor 461 is placed on a location suited for a portable information terminal 20 that has an outer shape (and a weight balance, and the like) different from the portable information terminal 10 in the above-mentioned embodiment. That is, this portable information terminal 20 is to be held not at the bottom but from the left side, and therefore, the hold detection sensor 461 is provided on the left side face. As described above, the sensor that functions as the hold detection section is disposed on a side face (not limited to the left or right face) that is defined as a face of the case different from the front surface having the display area and the back surface, such that the sensor can detect that the case is held by detecting the hand of the user approaching, touching, or pressing the sensor.

Further, the sensor that functions as the hold detection section may be disposed not on the side face but on the front surface. A hold detection sensor 561 shown in FIG. 14 is provided on the same surface as the display area 14. A portable information terminal 30 having the hold detection sensor 561 disposed thereon has the smaller display area 14 as compared with that of the portable information terminal 10 because a lower part of the display area 14 is not provided. The touch panel 161 is also made smaller by cutting the lower part thereof out so as to fit to this smaller display area 14. As a result, even if certain types of touch panels 161 may not be able to detect the thumb of the hand holding the device approaching, touching, or pressing the touch panel using the above-mentioned fixed coordinates, by disposing the hold detection sensor 561 on a location corresponding to the area of the fixed coordinates, a thumb approaching, touching, or pressing the hold detection sensor 561 can be detected. The location where the hold detection sensor 561 is disposed is usually pressed hard naturally by a thumb of the user in order for the user to hold the device, and therefore, a mechanical sensor such as a switch is preferable. This way, the touch panel 161 can be made smaller and an inexpensive mechanical switch can be used, thereby reducing the manufacturing cost of the device. Further, while the device is in the standby mode, the operation of the touch panel 161 and the processes related to the touch panel 161 can be completely stopped, thereby substantially reducing the power consumption. Furthermore, because it is natural to place the thumb on the front surface when holding the device, it is possible to detect easily and reliably that the device is held.

For the sensor, sensors other than the ones described above, such as a sensor for detecting body temperature and a sensor for detecting vibration, shaking, or the like caused by the hand holding the device, for example, may be used, as long as the sensor can detect that the device is held.

### 6.2 Other Modification Examples

The above-mentioned embodiment showed an example in which the commands for executing the respective processes (the mode switching process, the page process, and the like, for example) are associated with the click gesture and the slide gesture made by the respective fingers, but this example solely serves as illustration. Any gestures that are recognized as a result of change in two or more input coordinates that are associated to each other in a time series manner may be employed. Also, the process commands that have been stored in the device in advance to respond to those gestures may be any process commands that are performed in the portable information terminal. The following operations may be performed, for example: when a gesture of placing the index finger and the middle finger of one hand holding the device on the touch panel 261 and thereafter spreading the fingers, or when a gesture of moving the index finger from the lower left to the upper right is made, the command of zooming in the displayed image is executed; and conversely, when a gesture of placing the index finger and the middle finger on the touch panel 261 and thereafter bringing together the fingers, or when a gesture of moving the index finger from the upper right to the lower left is performed, the command of zooming out the displayed image is executed.

The click gesture was described as a gesture of the finger moving away from and thereafter being placed again on the touch panel 261, but the click gesture is not limited to such. The click gesture may be completed when the finger was moved away. The slide gesture was described as a gesture of the finger moving and thereafter stopping, but the slide gesture is not limited to such. The slide gesture may be completed when the finger started moving and the finger thereafter moved only for a certain distance or the finger was thereafter moved away. Further, the commands to be executed may be associated with a combination of the fingers (the index finger and the middle finger, for example) to be placed on the touch panel 261.

The command input operation in the above-mentioned embodiment may be limited to the click gesture or the press gesture made by the respective fingers. In this case, instead of the touch panel 261, various sensors including a switch such as an optical switch and a mechanical switch can be used. The device may be configured to be provided with four switches, four single touch panels, or the like that are to be pressed by the respective four fingers aside from the thumb of one hand holding the device, and to detect the press gestures made by the respective fingers, for example. When the mechanical switch is used, it is preferable that this switch have a known reaction force generation mechanism such as a spring, which cannot be pressed down by a force for holding the device, because the switch is pressed hard due to the force applied by the user to hold the device even when the above-mentioned press gesture is not made. If the touch panel 261 is a pressure-sensitive touch panel, or alternatively, if a sensor capable of detecting change in the pressing force generated by the above-mentioned press gesture is provided, it is possible to determine that the above-mentioned press gesture was performed even when the click gesture of temporarily moving away the finger was not performed, by detecting an increase in a pressing force from a level that is required to hold the device to a larger level as a result of receiving the press gesture.

In the above-mentioned embodiment, it was described that the thumb of one hand holding the portable information terminal pressed the area of the fixed coordinates located near the center of the screen of the display area 14. This is because a typical device is designed such that the part near the center of the screen is the easiest part to hold. However, the user may feel that the other parts are easier to hold. Also, the place to be typically considered easy to hold may change when accessories are attached to the device. In response, the above-mentioned area of the fixed coordinates may be changed to a prescribed area that is away from the area near the center of the screen, i.e., an appropriate area such as an area near the center of the left side of the display area 14, for example.

In the above-mentioned embodiment, the recognition process (S3) is performed after the command input process (S2) was completed. This process flow (including other process flows) solely serves as illustration for ease of explanation. The respective processes may be combined together, or a known process sequence such as an event-driven type process may be employed.

In the above-mentioned embodiment, the types of the gestures such as a click gesture and a slide gesture made by the respective fingers and the commands (contents of the processes) that correspond to the respective gestures are stored statically in the application. However, this relationship of correspondence between the commands and the gestures may be changed as desired by the user or by application.

In the above-mentioned embodiment, the recognition of the gestures such as the slide gesture is performed based on the coordinates of the starting point and the coordinates of the end point. Alternatively, the following known methods of recognizing various gestures can be employed, for example: a method of recognizing the gestures by a known pattern recognition, a method of performing a prescribed vector operation; a method of determining which of the above-mentioned gestures the presented gesture corresponds to, based on a change in the associated (i.e., a series of) groups of the coordinates that are stored per unit time; and the like.

In the above-mentioned embodiment, an example of performing the command recognition described above in the portable information terminal was described. Such command recognition can also be performed in known devices such as a mobile phone, an electronic organizer, an electronic dictionary, an electronic book terminal, a game terminal, and a mobile internet terminal, which are portable information terminals to be held by a user.

In the above-mentioned embodiment, the portable information terminal to be held in one hand was described as an example, but the device may be held in one hand or in both hands. Further, the present invention can be also applied to portable information terminals that are designed to be held in both hands. A part of the case on the left side may be held in the left hand, and a part of the case on the right side may be held in the right hand, for example. In this case, the thumbs of the respective hands are placed on the front surface, and the respective fingers excluding the thumbs are placed on the back surface. Therefore, operation resulting from the fingers excluding the thumbs (that hold the device) approaching, touching, or pressing the touch panel 261, which is the input section on the back surface, may be recognized, and the pre-associated process commands may be executed in response to the recognized finger operation. This way, an input interface suited for operation to be made by each of the hands can be provided. Further, if the device is configured such that the device becomes capable of receiving the commands when the thumbs (that hold the device) press the area near the center of the screen where the fixed coordinates are located and the device becomes incapable of receiving the commands when the portable information terminal is not held, it becomes possible to prevent the commands from being accidentally executed by an unintentional touch on the display screen, or the like. This makes it possible to provide the input interface suited for operation to be made by each of the hands.

### INDUSTRIAL APPLICABILITY

The present invention relates to a portable information terminal having a display area, such as a mobile phone, an electronic organizer, an electronic dictionary, an electronic book terminal, a game terminal, and a mobile internet terminal. The present invention is suitable for a portable information terminal that is provided with a sensor for detecting fingers of a hand of a user approaching, touching, or pressing the back of the display area, thereby recognizing commands.

### DESCRIPTION OF REFERENCE CHARACTERS

10, 20, 30 portable information terminal
14 display area
100 control section
141 liquid crystal panel
142 scan driver
143 data driver
145 display control section
162, 262 Y-coordinate sensor
163, 263 X-coordinate sensor
160 input section
161, 261 touch panel
165 first coordinates process section
265 second coordinates process section
1401 area of fixed coordinates
P command recognition program

1. A portable information terminal equipped with a case that can be held by a user, comprising:
a display area disposed on a front surface of the case, the display area being provided to display an image;
a rear input section disposed on a back surface of the case on a reverse side from the front surface, the rear input section being provided to receive an operation input resulting from two or more fingers of the user approaching, touching, or pressing the rear input section;
a hold detection section that detects holding of the case by the user; and
a command recognition section that recognizes an operation input resulting from the fingers approaching, touching, or pressing the rear input section, the command recognition section executing a pre-associated process command in response to the recognized operation input made by said finger,
wherein, when the hold detection section does not detect holding of the case, the command recognition section switches to a command non-receiving state in which the process command is not executed, and when the hold detection section detects holding of the case, the command recognition section switches to a command receiving state in which the process command can be executed.

2. The portable information terminal according to claim 1, wherein the hold detection section is disposed on the front surface of the case, and detects holding of the case by detecting a thumb of the user approaching, touching, or pressing the hold detection section.

3. The portable information terminal according to claim 2, wherein the hold detection section has a front input section that can obtain two or more coordinates on the display area, including coordinates that a thumb of the user approached, touched, or pressed, and the hold detection section detects holding of the case when the front input section obtains fixed coordinates in the display area that are to be approached, touched, or pressed by the thumb of the user when the case is held.

4. The portable information terminal according to claim 3, wherein, during a period in which the command recognition section is in the command non-receiving state, the front input section obtains the coordinates by performing at least one of the following operations: limiting an area of coordinates to be obtained on the display area to an area of the fixed coordinates or to an area near the fixed coordinates; and setting a time interval at which coordinates on the display area are to be obtained longer than said time interval during the command receiving state.

5. The portable information terminal according to claim 1, wherein the hold detection section is disposed on a side face that is a face of the case different from the back surface and the front surface, and the hold detection section detects holding of the case by detecting a hand of the user approaching, touching, or pressing the hold detection section.

6. The portable information terminal according to claim 1, wherein the rear input section receives an input made by four fingers other than the thumb of the user, and
wherein, when one of the fingers that at one time approached, touched, or pressed the rear input section was moved away or stopped touching or pressing the rear input section, and thereafter approached, touched, or pressed the rear input section again, the command recognition section executes a pre-associated process command in response to an operation input by said finger.

7. The portable information terminal according to claim 1, wherein, when coordinates that the fingers approach, touch, or press are changed, the command recognition section executes a pre-associated process command in response to the change.

8. A method of controlling a portable information terminal equipped with a case that can be held by a user, the method comprising:
a display step of displaying an image on a display area disposed on a front surface that is a prescribed surface of the case;
a rear input step of receiving an operation input resulting from two or more fingers of the user approaching, touching, or pressing a rear input section disposed on a back surface that is a surface of the case on a reverse side from the front surface;
a hold detection step of detecting holding of the case by the user; and
a command recognition step of recognizing an operation input made in the rear input step by the fingers approaching, touching, or pressing the rear input section, and executing a pre-associated process command in response to a recognized operation input made by said finger,
wherein, in the command recognition step, when holding of the case is not detected in the hold detection step, the process command is not executed, establishing a command non-receiving state, and when holding of the case is detected in the hold detection step, the process command can be executed, establishing a command receiving state.
